(19) United States
(12) Patent Application Publication
(10) Pub. No.: US 2013/0337910 A1
(43) Pub. Date: Dec. 19, 2013

(54) CONTEST MANAGEMENT SYSTEM AND METHOD

(71) Applicant: Rick J. Germany, Las Vegas, NV (US)

(72) Inventor: Rick J. Germany, Las Vegas, NV (US)

(21) Appl. No.: 13/919,527

(22) Filed: Jun. 17, 2013

Related U.S. Application Data
(60) Provisional application No. 61/661,575, filed on Jun. 19, 2012.

(51) Int. Cl. G07F 17/32

(52) U.S. Cl. CPC G07F 17/3225
USPC 463/29

(57) ABSTRACT

There is a contest management system and method for managing a contest over a computerized network. The contest management system includes a contest management module that manages a progressive prize contest over a computerized network. The contest management system includes an entrant interface module that provides an interactive user interface to an entrant and automatically observe, using a computing device over a computerized network, a characteristic set of an entry action by an entrant. The contest management system includes a sponsor module: compares the characteristic set against a stored minimum condition set, using a processor; ratifies, automatically, the entry action to the contest management module if the characteristic set satisfies the minimum condition set; and automatically issues a debit instruction to an account of the contest sponsor in association with ratifying the entry action.

### CROSS-REFERENCE TO RELATED APPLICATIONS

This invention claims priority, under 35 U.S.C. §120, to the U.S. Provisional Patent Application No. 61/661,575 to Rick Germany filed on Jun. 19, 2012, which is incorporated by reference herein.

### BACKGROUND OF THE INVENTION

1. Field of the Invention

The present invention relates to using contests for promotional purposes, specifically to a contest management system and method.

2. Description of the Related Art

Contests may be used for promotional purposes, wherein a contest sponsor offers a prize in hopes of exciting participants into spreading the word about the contest and thereby providing some direct and/or collateral benefit to the contest sponsor. In the case of a lottery, the benefit is in entry sales as it is necessary to purchase an entry into the lottery. In the case of other contests, the benefit(s) may be in increased brand awareness, cause awareness, entry into an early phase of a sales funnel, contact information to add to a marketing list, and the like. Generally a prize is awarded to one or more entrants into a contest and the excitement surrounding the contest is derived from the fact that the prize(s) awarded have a value far greater than the effort/money put forward by the entrant(s) who win. Contest sponsors often use marketing techniques and tools to associate this excitement with their brand or cause.

Marketing is the process of communicating the value of a product or service to customers, for the purpose of selling the product or service. It is a critical business function for attracting customers. Promotion is one of the market mix elements, and a term used frequently in marketing.

In some cases, marketing and/or contests are managed using computerized systems, thereby automating one or more aspects of the marketing and/or contest efforts. In some cases, entrants are able to enter a contest online over a computerized network, generally by providing a bit of contact information, such as but not limited to an email address. This contact information may then be used after the contest is over to contact all participants for further marketing purposes and/or to make announcements to persons who may have a particular interest in the announcement. Computers may also be used to randomly select winners and/or provide notifications to the same.

Some improvements have been made in the field. Examples of references related to the present invention are described below in their own words, and the supporting teachings of each reference are incorporated by reference herein:

U.S. Pat. No. 8,234,193, issued to Ransom et al., disclose systems and methods for providing online promotions integrated with social network-based platforms are disclosed. Promotion details such as rules, offered prizes, incentives and descriptions, survey questions, display banners, terms and conditions, privacy policy, and social networks to integrate the promotion with, are provided by the sponsoring organization to a server. The server generates a custom promotion application and/or widget for integrating with the organization's social network webpage and/or webpages external to social networks. A participant enters the promotion through these webpages or other links and lists friends in the social network to receive an invitation to enter the promotion. Viral features such as friend invite features, newsfeeds, minifeeds, other features that display online activities of users and people in the users' social network, notifications, requests, and other social network-based platform features to deliver messages to members of the one or more social network-based platforms further spread the word about the organization's promotion.

U.S. Pat. No. 7,054,830, issued to Eggleston et al., discloses a method and system for providing incentive programs over a computer network is provided in which a host may provide sponsoring companies with the capability to buy prepackaged or self-built incentive programs, offer such incentive programs to consumers, provide sponsoring companies and retailers with the capability to associate prizes with incentive programs, provide sponsoring companies, retailers and consumers with convenient fulfillment of prizes, and store and manipulate databases regarding all of the foregoing.

U.S. Pat. No. 7,725,350, issued to Schlee, discloses a promotional data delivery system and method are disclosed by which promoters input to a host computing system their preferred consumer criteria and define their promotional materials, customers provide profiling information and select promotional materials, and a host relates the data pertaining to the promoters and customers to provide or otherwise communicate, preferably in tangible form such as paper via mail or parcel delivery services, promotional information including coupons particularly targeted for and/or selected by the prospective customers.

U.S. Patent Application Publication No. 2007/0143181, by Linkler et al., discloses systems and methods for providing web-based promotions and promotional tools. The system allows smaller marketers to quickly and easily build and deploy a customized and professional web-based promotion using a fully automated interactive promotional tool including a wizard-driven web interface. The promotion wizard guides an advertiser through the process of designing all aspects of an online promotion including the selection of one or more prize pools and types of promotions, as well as uploading logos and selecting other aesthetic aspects of the promotion. The promotion is preferably distributed using unique distribution channels, and the advertiser is provided with a variety of administrative and management functions by the system in order to manage certain aspects of the online promotion.

U.S. Patent Application Publication No. 2012/0252558, by Mishra et al., discloses methods are provided that allow promotional offers to be distributed through the play of an electronic game application. The method may include use of a handheld device, location-based targeting of offers such as deals, advertisements, and coupons, and offer prioritization based on user playing history. The method may involve a server through which offers are distributed. The method may include receiving requests from sponsors to create promotional offers. In some embodiments, the use of rank in a high score database may help determine which players receive a prize.

The inventions heretofore known suffer from a number of disadvantages which include being complicated to enter, being complex, being cumbersome to use, being limited in application, making it difficult for individual businesses to promote their business, only effectively promoting businesses as opposed to being able to also promote the interests of non-profit organizations, providing only static prizes and/or not being able to offer a dynamic prize and/or progressive prize, including only limited advertising activities/models, not permitting entrants to share entry actions, providing no or limited visibility to sponsors and/or entrants and/or their actions, taking too long to get a contest up and running, being limited in use, being limited in industry, being limited in promotional capabilities, being limited in funding targets, being limited in prizes or rewards, being limited in advertising, being limited in exposure, and being lengthy in time to start and manage.

What is needed is a contest management system and method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available contest management systems and methods. Accordingly, the present invention has been developed to provide a contest management system and method that manages a contest over a computerized network.

According to one embodiment of the invention, there is a method of managing a contest system over a computerized network. The method may include the step of receiving an action requirement set from a contest sponsor, wherein the action requirement set may include a minimum condition set of entry actions for a sponsor to fund a contest entry. The minimum condition set may include a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

The method may include the step of storing the action requirement set in association with a contest in a memory storage device. The method may include automatically observing, using a computing device over a computerized network, a characteristic set of an entry action by an entrant. The method may include the step of comparing the characteristic set against the minimum condition set, using a processor. The method may include the step of ratifying, automatically, the entry action to a contest management module if the characteristic set satisfies the minimum condition set.

The method of managing a contest system over a computerized network may include the step of automatically issuing a debit instruction to an account of the contest sponsor in association with ratifying the entry action. The method may include the step of posting a contest entry associated with the entrant if the entry action is ratified. The method may include the step of rewarding a winning entrant for winning a contest based on a ratified entry action by the winning entrant, wherein the entry action by the winning entrant did not include paying any money. The method may include the step of rewarding a funding target with a predetermined portion of the revenue generated from a contest, including revenue derived from the contest sponsor.

The method of managing a contest system over a computerized network may include the step of automatically incrementing an award associated with the contest in association with automatically debiting an account of the contest sponsor. The method may include the step of publishing a plurality of diverse action requirement sets associated with the contest, each action requirement set associated with a diverse contest sponsor, over a computerized network. The method may include the step of publishing a streaming feed of contest entries including: descriptive information about entry actions taken by entrants, and a machine executable link to a user interface wherein users may take similar entry actions.

According to one embodiment of the invention, there is a method of managing a contest system over a computerized network. The method may include the step of receiving an action requirement set from a contest sponsor, wherein the action requirement set may include a minimum condition set of entry actions for a sponsor to fund a contest entry and the minimum condition set does not include payment of money. The method may include the step of storing the action requirement set in association with a contest in a memory storage device. The method may include the step of automatically observing, using a computing device over a computerized network, a characteristic set of an entry action by an entrant. The method may include the step of comparing the characteristic set against the minimum condition set, using a processor. The method may include the step of ratifying, automatically, the entry action to a contest management module if the characteristic set satisfies the minimum condition set. The method may include the step of automatically issuing a debit instruction to an account of the contest sponsor in association with ratifying the entry action. The method may include the step of posting a contest entry associated with the entrant if the entry action is ratified. The method may include the step of automatically incrementing an award associated with the contest in association with posting the contest entry.

The method of managing a contest system over a computerized network may include the step of rewarding a winning entrant for winning a contest based on a ratified entry action by the winning entrant. The method may include the step of rewarding a funding target with a predetermined portion of the revenue generated from a contest. The method may include the step of publishing either a plurality of diverse action requirement sets associated with the contest, each action requirement set associated with a diverse contest sponsor, over a computerized network or a streaming feed of contest entries including: descriptive information about entry actions taken by entrants, and a machine executable link to a user interface wherein users may take similar entry actions.

According to one embodiment of the invention, there is a contest management system for managing a contest over a computerized network. The contest management system may include a contest management module that may manage a progressive prize contest over a computerized network and post a contest entry associated with an entrant if an associated entry action is ratified. The contest management module may include a prize module that increments a progressive prize in association with ratified entries. The contest management module may include an entry feed generation module that may be in communication with a computerized network and publish a streaming feed of contest entries that may include: descriptive information about entry actions taken by entrants, and a machine executable link to a user interface wherein users may take similar entry actions. The contest management module may include an account management module that may be in communication with the entry feed generation module and manages an account of an entrant. The contest management module may include a validation module that may be in communication with the account management module and validates contest entries in association with ratified entry information received from the sponsor module.

The contest management system may include an entrant interface module that may be in communication with the contest management module and provides an interactive user interface to an entrant and automatically observe, using a computing device over a computerized network, a characteristic set of an entry action by an entrant. The entrant interface module may include an account interface module that facilitates user management of an account of an entrant. The entrant interface module may include an interface module that may be in communication with the account module and provides a graphical user interface for an entrant. The entrant interface module may include an observation module that may be in communication with the account module and observes entry actions. The entrant interface module may include a suggestion module that may be in communication with the account interface module and interface module and provides suggestions over the interface module regarding entry methods for entries into a contest over a computerized network.

The contest management system may include a sponsor module that may be in communication with the contest management module and the entrant interface module and may: compare the characteristic set against a stored minimum condition set, using a processor; ratify, automatically, the entry action to the contest management module if the characteristic set satisfies the minimum condition set; and automatically issue a debit instruction to an account of the contest sponsor in association with ratifying the entry action. The sponsor module may include an comparison module that compare the characteristic set against a stored minimum condition set, using a processor, wherein the minimum condition set does not include the entrant paying a fee. The sponsor module may include a ratification module that may be in communication with the comparison module and ratify, automatically, the entry action to a contest management module if the characteristic set satisfies the minimum condition set. The sponsor module may include a debit module that may be in communication with the ratification module and automatically issue a debit instruction over a computerized network to an account of the contest sponsor in association with ratifying the entry action and issue an associated credit instruction to an account of the contest management module.

The contest management system may include a publisher module that may be in communication with the entrant interface module. The publisher module may include at least one of: an entry option module that publish a plurality of diverse action requirement sets associated with the contest, each action requirement set associated with a diverse contest sponsor, over a computerized network; or an entry stream module that may be in communication with the contest management module and publish a live streaming feed of contest entries that may include: descriptive information about entry actions taken by entrants, and a machine executable link to a user interface wherein users may take similar entry actions.

The contest management system may include a funding target module that may be in communication with the contest management module and the entrant interface module and reward a charity with a portion of the revenue generated by the contest. The minimum condition set may include a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a contest management system, according to one embodiment of the invention;

FIG. 2 is an activity flow model of a contest management system and method in operation, according to one embodiment of the invention;

FIG. 3 is an activity flow model of a set of entities related to a contest of a contest management system and method, according to one embodiment of the invention;

FIG. 4 is a module diagram of a contest management module of a contest management system, according to one embodiment of the invention;

FIG. 5 is a module diagram of a sponsor module of a contest management system, according to one embodiment of the invention;

FIG. 6 is a module diagram of an entrant interface module of a contest management system, according to one embodiment of the invention;

FIG. 7 is a module diagram of a publisher module of a contest management system, according to one embodiment of the invention;

FIG. 8 is a module diagram of a funding target module of a contest management system, according to one embodiment of the invention; and

FIG. 9 is a flowchart of a method of managing a contest, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of programmable or executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module and/or a program of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The various system components and/or modules discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. As those skilled in the art will appreciate, any computers discussed herein may include an operating system (e.g., Windows Vista, NT, 95/98/2000, OS2; UNIX; Linux; Solaris; MacOS; and etc.) as well as various conventional support software and drivers typically associated with computers. The computers may be in a home or business environment with access to a network. In an exemplary embodiment, access is through the Internet through a commercially-available web-browser software package.

The present invention may be described herein in terms of functional block components, screen shots, user interaction, optional selections, various processing steps, and the like. Each of such described herein may be one or more modules in exemplary embodiments of the invention. It should be appreciated that such functional blocks may be realized by any number of hardware and/or software components ### perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, AJAX, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units and/or modules. Being “in communication” refers to any manner and/or way in which functional units and/or modules, such as, but not limited to, computers, laptop computers, PDAs, modules, and other types of hardware and/or software, may be in communication with each other.

Some non-limiting examples include communicating, sending, and/or receiving data and metadata via: a network, a wireless network, software, instructions, circuitry, phone lines, internet lines, satellite signals, electric signals, electrical and magnetic fields and/or pulses, and/or so forth.

As used herein, the term “network” may include any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

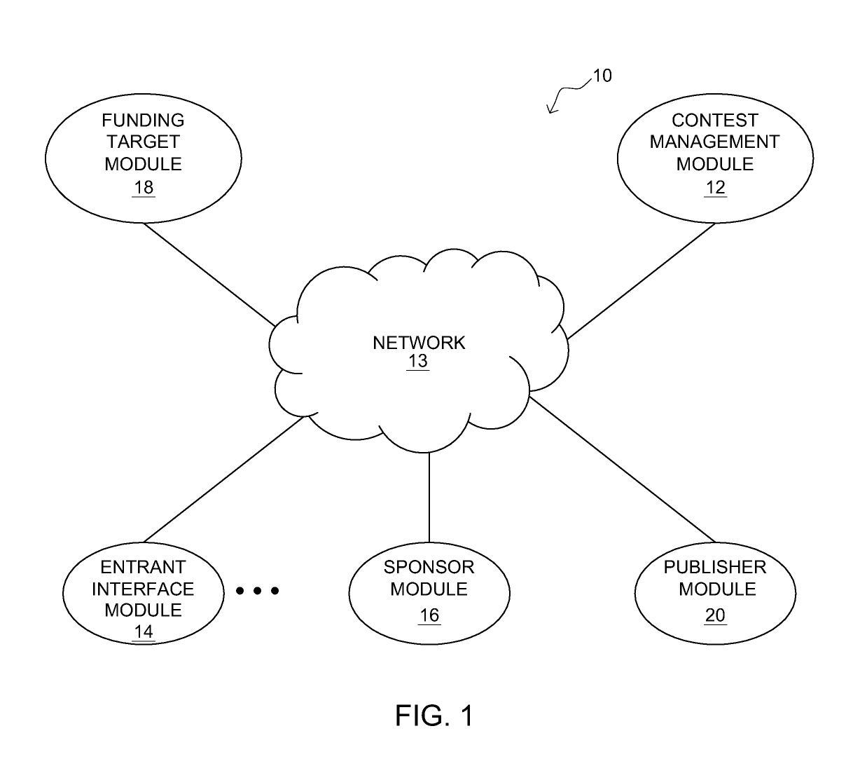

FIG. 1 is a network diagram of a contest management system, according to one embodiment of the invention. There is shown a contest management system including a contest management module 12, an entrant interface module 14, a sponsor module 16, a funding target module 18, and a publisher module 20 each in communication over a computerized network 13. The illustrated system 10 allows for a contest to be held and managed over a computerized network, such that contest entrants may enter a contest over the network, sponsors may sponsor the same over a network, details of the contest may be published over the network, the contest may be managed over a network and a funding target (such as but not limited to a charitable organization) may be funded through operation of the contest over a network.

According to one embodiment of the invention, there is a contest management system 10 for managing a contest over a computerized network 13. The contest management system 10 includes a contest management module 12 that manages a progressive prize contest over a computerized network 13. The illustrated contest management module 12 tracks and/or posts valid contest entries associated with entrants. The contest management module 12 also manages/controls/increments a progressive prize in association with valid/ratified entries. The contest management module 12 provides a streaming feed of contest information, including but not limited to entry and/or prize information and/or information relating to any of the entities involved in the contest. The contest management module 12 also manages/controls/regulates entrant accounts, including but not limited to managing entries by entrants into multiple contests and/or multiple entries by an entrant into a single contest. The contest management module 12 tracks validity/ratification of contest entries in association with entry information received from a sponsor module 16 and/or from entrant interface modules 14.

The contest management system 10 includes a plurality of entrant interface modules 14 in communication with the contest management module 12 and provides an interactive user interface to an entrant. The entrant interface module 14 automatically observes, using a computing device over a computerized network 13, a characteristic set of an entry action by an entrant. The entrant interface module 14 facilitates user management of an account of an entrant. The entrant interface module 14 provides a graphical user interface for an entrant. The entrant interface module 14 observes entry actions. The entrant interface module 14 provides suggestions regarding entry methods for entries into a contest over a computerized network 13.

The contest management system 10 may include a sponsor module 16 is in communication with the contest management module 12 and the plurality of entrant interface modules 14 and: compare the characteristic set against a stored minimum condition set, using a processor; ratify, automatically, the entry action to the contest management module 12 if the characteristic set satisfies the minimum condition set; and automatically issue a debit instruction to an account of the contest sponsor in association with ratifying the entry action. The sponsor module 16 compares the characteristic set against a stored minimum condition set, using a processor, wherein the minimum condition set does not include the entrant paying a fee. In one non-limiting example of stored minimum condition sets that do not include the entrant paying and entry fee, the stored minimum condition set may include one or more of the following conditions: the IP address associated with the entrant is also concurrently associated with a record of a video having been viewed over a network, the email address associated with an entry is associated with an email address that has been validated through a validation process as being an active email associated with the entry, a hash code associated with the entry has been observed by a webcrawler to have been posted in a twitter feed, contact information associated with an entry is confirmed to match contact information found in a customer database of the sponsor, and the like and combinations thereof. The sponsor module 16 ratifies, automatically, the entry action to a contest management module 12 if the characteristic set satisfies the minimum condition set. Such ratification may be by setting a flag associated with an entry record, by transmitting a ratification confirmation message identifying the entry, by not sending an error message, by not invalidating an entry and the like and combinations thereof. Validation/ratification processes may include encryption methods, systems and/or devices to protect the integrity of entries.

The sponsor module 16 automatically issues a debit instruction over a computerized network 13 to an account of the contest sponsor in association with ratifying the entry action and issue an associated credit instruction to an account of the contest management module 12. Such a debit notification may be merely a record keeping notification that is acted on by a third party or may be an actual command that alters an account balance. The word “debit” as used herein means merely to alter an account, and does not mean that an official accounting debit entry must be made according to double entry accounting practices. It is understood that various accounting practices may be used that are not traditional double entry accounting and still a “debit instruction” as described herein may be performed.

The contest management system 10 includes a publisher module 20 in communication with the plurality of entrant interface module 14. The publisher module 20 publishes a plurality of diverse action requirement sets associated with the contest, each action requirement set associated with a diverse contest sponsor, over a computerized network 13. As a non-limiting example, there may be three diverse sponsors of a particular contest. The first sponsor may require that entrants view a six minute video about their services in order for an entry by a particular entrant to be validated and may only validate one entry per person. The second sponsor may require that entrants post a predefined message on their social media platform associated with their account in order to validate an entry and may limit validation of entries to one validation per entrant per day. The third sponsor may require that entrants interact with a scripted program (fill out a questionnaire, play a game, solve a puzzle, etc.) and may only validate entries by entrants to satisfy specific conditions found within the scripted program (meet specific demographic conditions asked about in the questionnaire, win the game, solve the puzzle, etc.). The minimum condition set may include a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list. The publisher module 20 generally publishes a live streaming feed of contest entries which may be published via an RSS feed, a streaming ticker, a scrolling data feed, a regularly updating social media profile and the like and combinations thereof.

The contest management system 10 includes a funding target module 18 in communication with the contest management module 12 and the plurality of entrant interface modules 14. The funding target module 12 rewards a charity, startup business, or other funding target with a portion of the revenue generated by the contest. This may be accomplished by automatically crediting an account associated with the funding target entity in association with entries being recorded, fees being collected, prizes being awarded and the like and combinations thereof; by providing them the enhanced publicity through access to the entrants and/or visibility on notices and published materials associated with the contest and the like and combinations thereof. Additionally, the funding target entity may be able to validate entries without an associated fee payment and thereby may benefit from actions, fees, etc. from entrants without a corresponding contest fee cost. The funding target module 18 may manage, control, authorize, and/or otherwise facilitate/permit such activities by, to and from the funding target entity over a network.

According to one embodiment of the invention, there is a contest management system and method provides a crowd funding promotion managed over a computerized network with monthly checks to affiliated charities or other funding target entities. Entrants may enter a contest to win a progressive prize over a computerized network and support their charities for free. The funding comes through affiliated merchants who pay for entry actions taken by entrants when entering a contest over a computerized network. Funding to a funding target may be automatically calculated and/or reported to one or more contest sponsors and values may be calculated that are associated with proportional amounts of target funding that may be associated with fees paid by a sponsor so that they can obtain credit for having funded the funding target, such as but not limited to as a tax deduction and/or marketing material and/or rights. Entrants are rewarded for taking entry actions from the merchants over a computerized network. Entrants may view a streaming feed of actions taken by other entrants that are view-able, so entrants may view what other entry actions are earning entries into contests over a computerized network. The stream targets particular entrants over a computerized network.

In one non-limiting example, there is a crowd funding promotion managed over a network by an embodiment of the system described herein wherein regular funds are paid to one or more affiliated charities or other funding targets such as but not limited to a startup business. In such an example, people (entrants) can enter to win a prize and simultaneously support one or more funding targets for free. The funding for the prize and for the support to the charities and/or funding targets comes through affiliated merchants who pay for actions taken by people who enter when they enter. People are rewarded for taking actions that merchants want them to take. There is a streaming feed of actions taken by entrants that is view-able so other people can see what actions are earning entries and/or other meta-data about the entries, such as but not limited to who is entering, how often, how many times, from what part of the country are entries taking place, how high a progressive prize is, how much funding has been raised for a particular entity and the like and combinations thereof. The stream may be targeted instead of just wide open and/or universally accessible. As a non-limiting example, the stream may be available only to particular entrants, user, customers, or other group. As another non-limiting example, streamed feed content may be filtered, augmented and/or sorted based on one or more characteristics of the recipients. For example, priority and/or emphasis may be placed on data from a feed that is geographically more relevant (e.g. entries from entrants nearby) to a particular viewer of the feed and/or geographically remote information may be filtered, removed or otherwise deemphasized. There may be a system and/or module that verifies actions taken by entrants and validates their entry based on a match between entry actions taken and entry requirements known to the system/module.

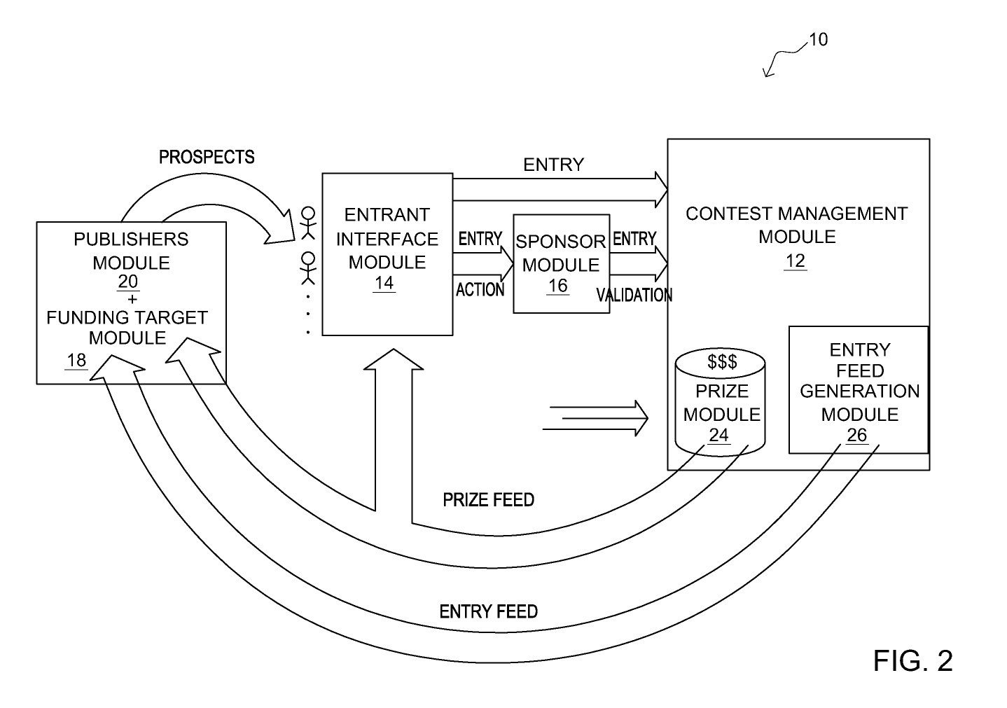

FIG. 2 is an activity flow model of a contest management system and method, according to one embodiment of the invention. There is shown a method of managing a contest including a contest management system 10 having a contest management module 12 in communication with a sponsor module 16, an entrant interface module 14, publishers 20 and funding targets 18 over a computerized network.

According to one embodiment of the invention, there is a contest management system 10 for managing a contest over a computerized network. The contest management system 10 includes a contest management module 12 manages a progressive prize contest over a computerized network and posts a contest entry associated with an entrant if an associated entry action is ratified. The contest management module 10 includes a prize module 24 increments a progressive prize in association with ratified entries. The contest management module 10 includes an entry feed generation module 26 in communication with a computerized network and publishes a streaming feed of contest entries that include: descriptive information about entry actions taken by entrants, and a machine executable link to an entrant interface wherein entrants take similar entry actions.

The contest management system 10 includes an entrant interface module 14 provides a plurality of entrants, a user interface over a computerized network. The entrant interface module 14 is in communication with the contest management module 12 and automatically observes, using a computing device over a computerized network, a characteristic set of an entry action by an entrant.

The contest management system 10 includes a sponsor module 16 in communication with the contest management module 12 and the entrant interface module 14 and: compare the characteristic set against a stored minimum condition set, using a processor; ratify, automatically, the entry action to the contest management module if the characteristic set satisfies the minimum condition set; and automatically issue a debit instruction to an account of the contest sponsor in association with ratifying the entry action.

The contest management system 10 includes a publisher module 20 and a funding target module 18 in communication with the entrant interface module 14. The publisher module 20 publishes a plurality of diverse action requirement sets associated with the contest, each action requirement set associated with a diverse contest sponsor, over a computerized network. The publisher module 20 publishes a live streaming feed of contest entries that include: descriptive information about entry actions taken by entrants, and a machine executable link to a user interface wherein users may take similar entry actions. The funding target module 18 is in communication with the contest management module 12 and the entrant interface module 14 and rewards a charity with a portion of the revenue generated by the contest.

According to one embodiment of the invention, there is a method of managing a contest system over a computerized network. The method includes the step of receiving an action requirement set from a contest sponsor, wherein the action requirement set may include a minimum condition set of entry actions for a sponsor to fund a contest entry. The minimum condition set may include a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

The method includes the step of storing the action requirement set in association with a contest in a memory storage device. The method includes automatically observing, using a computing device over a computerized network, a characteristic set of an entry action by an entrant. The method includes the step of comparing the characteristic set against the minimum condition set, using a processor. The method includes the step of ratifying, automatically, the entry action to a contest management module if the characteristic set satisfies the minimum condition set.

The method of managing a contest system over a computerized network includes the step of automatically issuing a debit instruction to an account of the contest sponsor in association with ratifying the entry action. The method includes the step of posting a contest entry associated with the entrant if the entry action is ratified. The method includes the step of rewarding a winning entrant for winning a contest based on a ratified entry action by the winning entrant, wherein the entry action by the winning entrant did not include paying any money. The method includes the step of rewarding a funding target with a predetermined portion of the revenue generated from a contest, including revenue derived from the contest sponsor.

The method of managing a contest system over a computerized network includes the step of automatically incrementing an award associated with the contest in association with automatically debiting an account of the contest sponsor. The method includes the step of publishing a plurality of diverse action requirement sets associated with the contest, each action requirement set associated with a diverse contest sponsor, over a computerized network. The method may include the step of publishing a streaming feed of contest entries including: descriptive information about entry actions taken by entrants, and a machine executable link to a user interface wherein users may take similar entry actions.

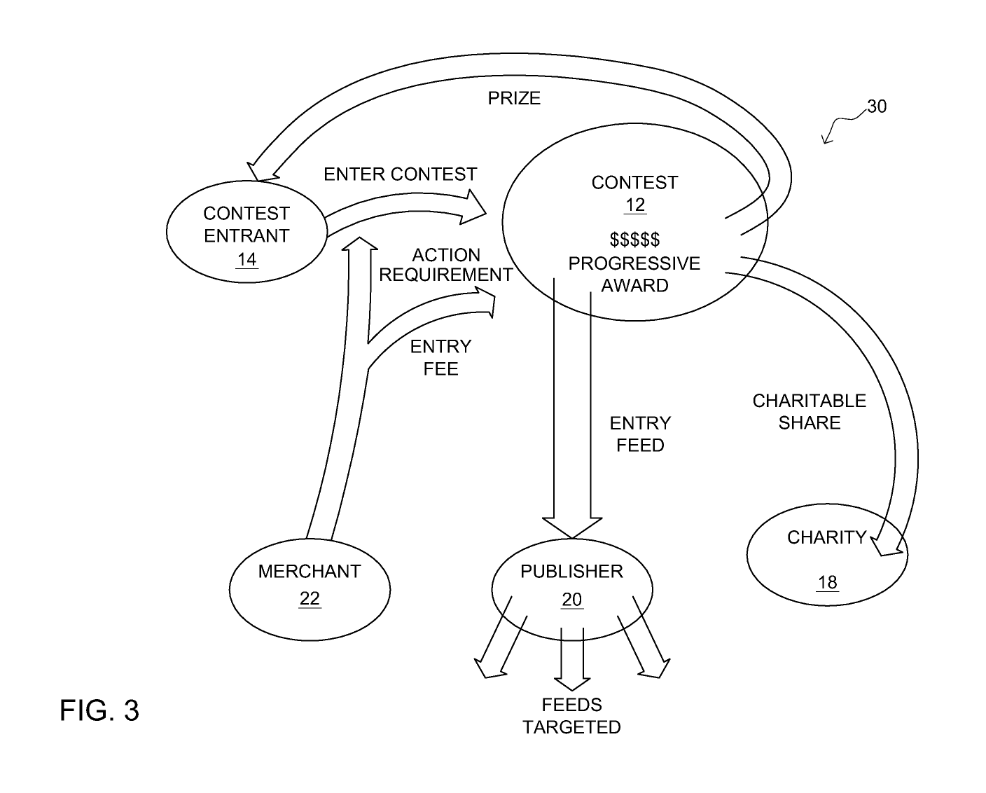

FIG. 3 is an activity flow model of a set of entities related to a contest of a contest management system and method, according to one embodiment of the invention. There is a method of managing a contest system over a computerized network, including a contest 12, a charity 18, a publisher 20, a merchant 22, and a contest entrant 14.

According to one embodiment of the invention, there is a method of managing a contest over a computerized network 30 using a contest management system. The contest management system includes a contest management module providing a contest 12 that manages a progressive prize contest over a computerized network and posts a contest entry associated with a contest entrant 14 if an associated entry action is ratified. The contest 12 provides a charitable share of a progressive prize to a charity or charities 18 designated by contest entrants 14 and by the contest 12. The contest 12 also distributes entry feeds to publishers 20 for distribution and acknowledgement over a computerized network.

The method of managing a contest over a computerized network 30 using a contest management system includes the step of contest entrants 14 entering a contest 12 for a chance at winning a progressive prize. The method 30 includes the step of merchants 22 providing entry fees for contest entrants requiring the entrants to perform an action requirement step.

According to one embodiment of the invention, there is a method of managing a contest system over a computerized network. The method may include the step of receiving an action requirement set from a contest sponsor, wherein the action requirement set may include a minimum condition set of entry actions for a sponsor to fund a contest entry and the minimum condition set does not include payment of money. The method may include the step of storing the action requirement set in association with a contest in a memory storage device. The method may include the step of automatically observing, using a computing device over a computerized network, a characteristic set of an entry action by an entrant. The method may include the step of comparing the characteristic set against the minimum condition set, using a processor. The method may include the step of ratifying, automatically, the entry action to a contest management module if the characteristic set satisfies the minimum condition set. The method may include the step of automatically issuing a debit instruction to an account of the contest sponsor in association with ratifying the entry action. The method may include the step of posting a contest entry associated with the entrant if the entry action is ratified. The method may include the step of automatically incrementing an award associated with the contest in association with posting the contest entry.

The method of managing a contest system over a computerized network may include the step of rewarding a winning entrant for winning a contest based on a ratified entry action by the winning entrant. The method may include the step of rewarding a funding target with a predetermined portion of the revenue generated from a contest. The method may include the step of publishing either a plurality of diverse action requirement sets associated with the contest, each action requirement set associated with a diverse contest sponsor, over a computerized network or a streaming feed of contest entries including: descriptive information about entry actions taken by entrants, and a machine executable link to a user interface wherein users may take similar entry actions.

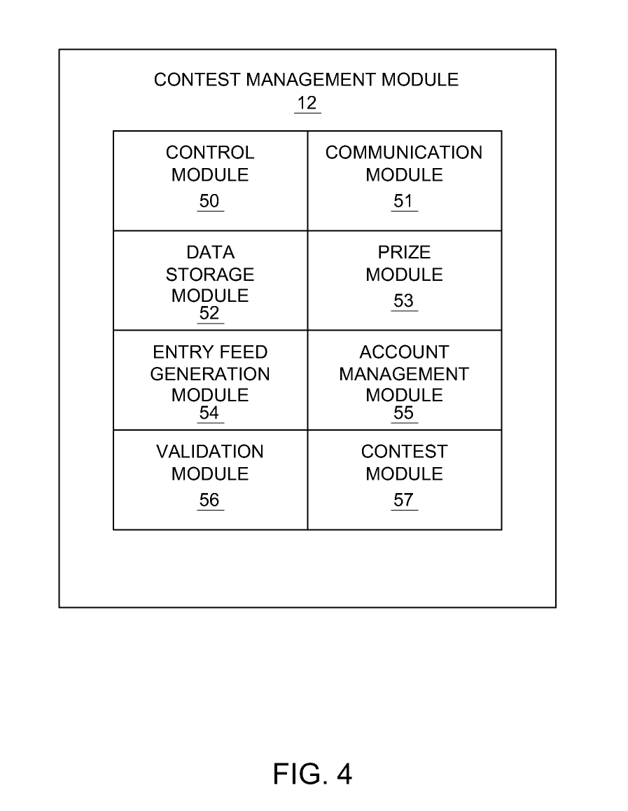

FIG. 4 is a module diagram of a contest management module of a contest management system, according to one embodiment of the invention. There is shown a contest management module 12 including a control module 50, communication module 51, a data storage module 52, a prize module 53, a entry feed generation module 54, an account management module 55, a validation module 56, and a contest module 57

The illustrated contest management module 12 manages a progressive prize contest over a computerized network. The contest management module 12 posts a contest entry associated with an entrant if an associated entry action is ratified. The contest management module 12 increments a progressive prize that are in association with ratified entries. The contest management module 12 publishes a streaming feed of contest entries. The contest management module 12 manages an account of an entrant.

The contest management module 12 validates contest entries in association with ratified entry information received from a sponsor module of a contest management system.

The illustrated contest management module 12 includes a control module 50 provides operational instructions and commands to the modules and components of the contest management module. The control module 50 is in communication with the modules and components of the contest management system (and/or other modules described herein) and provides managerial instructions and commands thereto. The source of such instructions/commands may be from one or more other modules described herein and/or through interactions between one or more other modules described herein. The control module 50 sets parameters and settings for each module and component of the contest management module. Non-limiting examples of a control module may be a control module described in U.S. Pat. No. 5,430,836, issued to Wolf et al.; or a control module described in U.S. Pat. No. 6,243,635, issued to Swan et al. which are incorporated for their supporting teachings herein. A control module may include but is not limited to a processor, a state machine, a script, a decision tree, and the like.

The illustrated contest management module 12 includes a communication module 51, such as a network card, system bus, or wireless communication module, and communicates with a computerized network. The communication module 51 provides communication capabilities, such as wireless communication, to the modules and components of the management module and the components and other modules described herein. The communication module 51 provides communication between a wireless device, such as a mobile phone, and a computerized network and/or to facilitate communication between a mobile device and other modules described herein. The communication module 51 may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated contest management module 12 includes a data storage module 52 in communication with the modules and components of the contest management module. The data storage module 52 collects and store data for each of the modules of the contest management module 12. The data storage module 52 is in communication with the various modules and components of the system for managing a contest over a computerized network and stores data transferred there through. The data storage module 52 stores data transferred through each of the modules of the contest management module, thereby updating the contest management system and the management module with up to date data and real time entrant and user data. The data storage module 52 securely stores user data along with data transferred through the contest management module. Data storage modules may be databases and/or data files and the memory storage device may be, but is not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated contest management module 12 includes a prize module 53 in communication with the modules and components of the contest management module 12. The prize module 53 increments a progressive prize that is in association with ratified entries. The prize module 53 provides a progressive cash prize to an entrant for winning a contest over a computerized network. The prize module 53 organizes a prize from a plurality of merchants or sponsors over a computerized network. The prize module provides a plurality of prizes to entrants based upon criteria or parameters met by entrants while completing entry actions in the contest over a computerized network. Non-limiting examples of a prize module may be a system as described in U.S. Pat. No. 8,353,761, issued to Kelly et al.; or a system as described in U.S. Pat. No. 7,980,947, issued to Michaelson et al., which are incorporated for their supporting teachings herein.

The contest management module 12 includes an entry feed generation module 54 in communication with a computerized network and publishes a streaming feed of contest entries that include: descriptive information about entry actions taken by entrants, and a machine executable link to a user interface wherein users may take similar entry actions. The entry feed generation module 54 provides entry feed data to publishers, funding targets, and entrants entering a contest over a computerized network. The entry feed generation module 54 provides a plurality of various entry feeds having entry actions for entrants to complete contest entries. Non-limiting examples of an entry feed generation module 54 may be a content generation platform as described in U.S. Pat. No. 8,397,212, issued to Chijiiwa; or a data feed engine as described in U.S. Pat. No. 8,326,796, issued to Farrell et al., which are incorporated for their supporting teachings herein.

The contest management module 12 includes an account management module 55 in communication with the entry feed generation module 54 and manages an account of an entrant. The account management module 55 manages a user account associated with an entrant. The account management module 54 stores and manages user account data, associated with the entrant, such as but not limited to: personal data, financial data, business data, charity data, user settings, user parameters, user preferences, etc. Non-limiting examples of an account management module may be an account management module as described in U.S. Patent Publication No.: 2003/0014509; or a management module as described in U.S. Pat. No. 8,265,650, which are incorporated for their supporting teachings herein.

The account management module 54 provides user account management capabilities. The account management module 54 stores and update user account data such as, but not limited to: characteristics, preferences, profiles, ratings, credentials, certifications, etc. associated with the user account. The account management module 54 stores and reference data associated with a specific entrant. Non-limiting examples of a management module may be an account creation module as described in U.S. Patent Publication No.: 2008/0281617, by Conrad et al.; or an account management system as described in U.S. Patent Publication No.: 2003/0028790, by Bleumer et al. which are incorporated by reference for their supporting teachings herein. The contest management module 12 includes a validation module 56 that is in communication with the account management module 55 and validates contest entries in association with ratified entry information received from a sponsor module. The validation module 56 validates an entry action, wherein if a characteristic set satisfies a minimum condition set. Non-limiting examples of a validation module may be a validation system as described in U.S. Pat. No. 8,418,142, issued to Ao et al.; or a validation module as described in U.S. Pat. No. 7,512,975, issued to Aissi; or a validation system as described in U.S. Pat. No. 8,290,808, issued to Roberts Jr. et al., which are incorporated for their supporting teachings herein.

The contest management module 12 includes a contest module 57 in communication with the modules and components of the contest management module 12. The contest module 57 provides a contest over a computerized network for entrants to enter and win prizes or rewards from merchants associated with the contest management system. Non-limiting examples of a contest module may be a system as described in U.S. Pat. No. 8,109,819, issued to Bollinger et al.; or a system as described in U.S. Pat. No. 7,162,433, issued to Foroutan, which are incorporated for their supporting teachings herein.

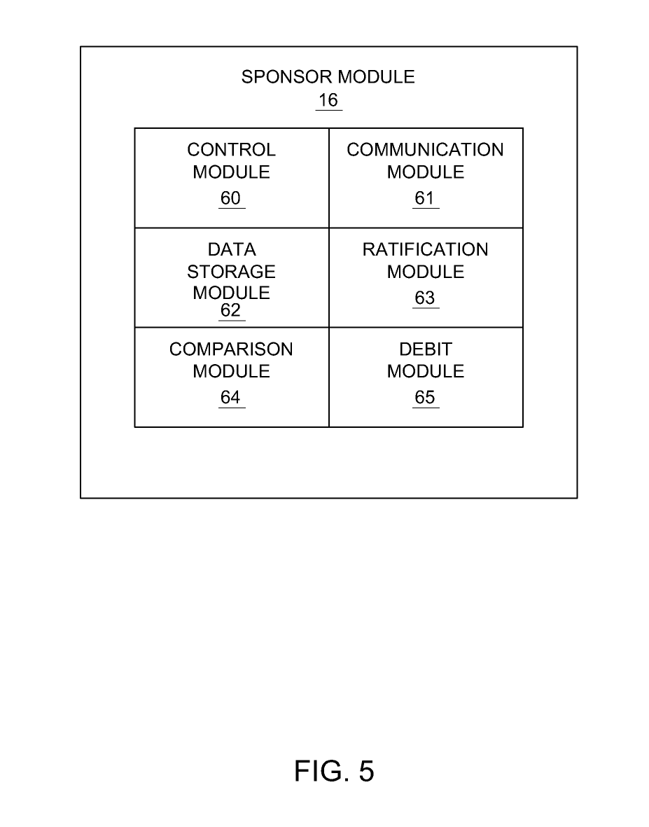

FIG. 5 is a module diagram of a sponsor module of a contest management system, according to one embodiment of the invention. There is shown a sponsor module 16 including a control module 60, a communication module 61, a data storage module 62, a ratification module 63, a comparison module 64, and a debit module 65.

The illustrated sponsor module 16 is in communication with the contest management module and the plurality of entrant interface modules of a contest management system over a computerized network. The sponsor module 16: compares the characteristic set against a stored minimum condition set, using a processor; ratifies, automatically, the entry action to the contest management module if the characteristic set satisfies the minimum condition set; and automatically issues a debit instruction to an account of the contest sponsor in association with ratifying the entry action. The sponsor module 16 compares the characteristic set against a stored minimum condition set, using a processor, wherein the minimum condition set does not include the entrant paying a fee. The sponsor module 16 ratifies, automatically, the entry action to a contest management module if the characteristic set satisfies the minimum condition set. The sponsor module 16 automatically issues a debit instruction over a computerized network to an account of the contest sponsor in association with ratifying the entry action and issue an associated credit instruction to an account of the contest management module.

The illustrated sponsor module 16 includes a control module 60 provides operational instructions and commands to the modules and components of the contest management module. The control module 60 is in communication with the modules and components of the contest management system (and/or other modules described herein) and provides managerial instructions and commands thereto. The source of such instructions/commands may be from one or more other modules described herein and/or through interactions between one or more other modules described herein. The control module 60 sets parameters and settings for each module and component of the contest management module.

The illustrated sponsor module 16 includes a communication module 61, such as a network card, system bus, or wireless communication module, and communicates with a computerized network. The communication module 61 provides communication capabilities, such as wireless communication, to the modules and components of the management module and the components and other modules described herein. The communication module 61 provides communication between a wireless device, such as a mobile phone, and a computerized network and/or to facilitate communication between a mobile device and other modules described herein. The communication module 61 may have a component thereof that is resident on a user's mobile device.

The illustrated sponsor module 16 includes a data storage module 62 in communication with the modules and components of the sponsor module 16. The data storage module 62 collects and store data for each of the modules of the sponsor module 16. The data storage module 62 is in communication with the various modules and components of the system for managing a contest over a computerized network and stores data transferred there through. The data storage module 62 stores data transferred through each of the modules of the sponsor module, thereby updating the contest management system and the sponsor module with up to date data and real time entrant and user data. The data storage module 62 securely stores user data along with data transferred through the contest management module.

The sponsor module 16 includes a comparison module 64 is in communication with the modules and components of the sponsor module 16. The comparison module 64 compares the characteristic set against a stored minimum condition set, using a processor, wherein the minimum condition set does not include the entrant paying a fee.

The sponsor module 16 includes a ratification module 63 in communication with the modules and components of the sponsor module 16. The ratification module 63 is in communication with the comparison module 64 and ratifies, automatically, the entry action to a contest management module if the characteristic set satisfies the minimum condition set. Non-limiting examples of a ratification module may be a ratification module as described in U.S. Pat. No. 8,006,290, issued to Agrawal et al., which is incorporated for their supporting teachings herein.

The sponsor module 16 includes a debit module 65 in communication with the ratification module 63 and automatically issues a debit instruction over a computerized network to an account of the contest sponsor in association with ratifying the entry action and issue an associated credit instruction to an account of the contest management module. Non-limiting examples of a debit module may be a system as described in U.S. Pat. No. 8,401,966, issued to Stewart et al.; or a debit module as described in U.S. Pat. No. 8,296,226, issued to Pratt et al., which are incorporated for their supporting teachings herein.

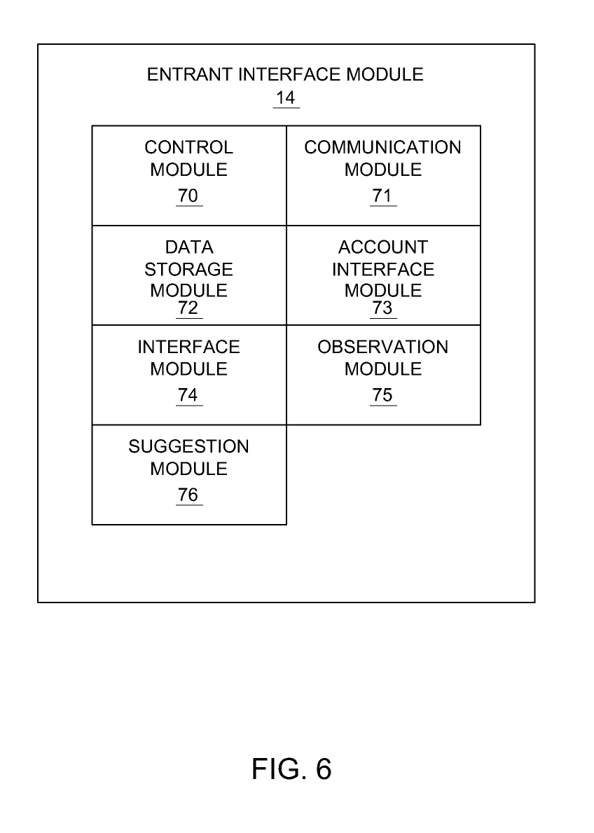

FIG. 6 is a module diagram of an entrant interface module of a contest management system, according to one embodiment of the invention. There is shown a entrant interface module 14 including a control module 70, a communication module 71, a data storage module 72, an account interface module 73, an interface module 74, an entry module 75, and a suggestion module 76.

The illustrated entrant interface module 14 is in communication with a contest management module of a contest management system. The entrant interface module 14 provides an interactive user interface to an entrant. The entrant interface module 14 automatically observes, using a computing device over a computerized network, a characteristic set of an entry action by an entrant. The entrant interface module 14 facilitates user management of an account of an entrant. The entrant interface module 14 provides a graphical user interface for an entrant. The entrant interface module 14 observes entry actions. The entrant interface module 14 provides suggestions regarding entry methods for entries into a contest over a computerized network 13.

The illustrated entrant interface module 14 includes a control module 70 provides operational instructions and commands to the modules and components of the entrant interface module 14. The control module 70 is in communication with the modules and components of the contest management system (and/or other modules described herein) and provides managerial instructions and commands thereto. The source of such instructions/commands may be from one or more other modules described herein and/or through interactions between one or more other modules described herein. The control module 70 sets parameters and settings for each module and component of the entrant interface module 14.

The illustrated entrant interface module 14 includes a communication module 71, such as a network card, system bus, or wireless communication module, and communicates with a computerized network. The communication module 71 provides communication capabilities, such as wireless communication, to the modules and components of the entrant interface module and the components and other modules described herein. The communication module 71 provides communication between a wireless device, such as a mobile phone, and a computerized network and/or to facilitate communication between a mobile device and other modules described herein. The communication module 71 may have a component thereof that is resident on a user's mobile device.

The illustrated entrant interface module 14 includes a data storage module 72 in communication with the modules and components of the entrant interface module 14. The data storage module 72 collects and store data for each of the modules of the entrant interface module 14. The data storage module 72 is in communication with the various modules and components of the system for managing a contest over a computerized network and stores data transferred there through. The data storage module 72 stores data transferred through each of the modules of the entrant interface module, thereby updating the contest management system and the entrant interface module with up to date data and real time entrant and user data. The data storage module 72 securely stores user data along with data transferred through the entrant interface module 14.

The illustrated entrant interface module 14 is in communication with a contest management module of a contest management system over a computerized network. The entrant interface module 14 provides an interactive user interface to an entrant and automatically observe, using a computing device over a computerized network, a characteristic set of an entry action by an entrant.

The illustrated entrant interface module 14 includes an account interface module 73 in communication with the modules and components of the entrant interface module 14. The account interface module facilitates user management of an account of an entrant. The illustrated entrant interface module 14 includes an interface module 74 is communication with the modules and components of the entrant interface module 14. The interface module 41 is in communication with the account module and provides a graphical user interface for an entrant. The interface module 74 provides a graphical user interface for an entrant to interact or complete entry actions for contest entries over a computerized network. Such may include one or more graphical user interfaces that may be embodied in software instructions for controlling display on a display (such as but not limited to a TV, monitor, cell phone/tablet screen, etc.) and/or for routing signals from an input device (such as but not limited to a keyboard, touchscreen, mouse, etc.) such that a user may perform data entries or queries in the system, issue suggestions or recommendations, and receive data information therefrom. Such may be embodied in one or more user interfaces that permit browsing of the system. Such may be embodied in one or more user interfaces that permit service personnel to make adjustments, changes, and otherwise provide personal profile updates to the system. Such may be embodied in one or more user interfaces that permit review of data from the system, such as but not limited to travel data, vacation data, profile data, other user profile data. Non-limiting examples of interface modules may be a HTML player, client server application, Java script application. A non-limiting example of an interface module is FlowPlayer 3.1, manufactured by FlowPlayer LTD, Hannuntie 8 D, ESPOO 02360, Helsinki, Finland. Non-limiting examples of a display/interface module may be a display/interface module as described in U.S. Pat. No. 6,272,562, issued to Scott et al.; a touch screen interface module as described in U.S. Pat. No. 5,884,202 and U.S. Pat. No. 6,094,609, issued to Arjomand, which are incorporated for their supporting teachings herein.

The illustrated entrant interface module 14 includes an observation module 75 in communication with the account module and observes entry actions. The observation module 75 observes entry actions and interactions with the entrant, wherein the interactions are stored and dated for future reference. Non-limiting examples of an observation module may be a system as described in U.S. Patent Publication No.: 2012/0310696, by Toth; or a system as described in U.S. Pat. No. 7,308,497, issued to Bennett et al., which are incorporated for their supporting teachings herein.

The illustrated entrant interface module 14 includes a suggestion module 76 is in communication with the account interface module 73 and the interface module 74. The suggestion module 76 provides suggestions over the interface module regarding entry methods for entries into a contest over a computerized network. The suggestion module 76 researches entrant interactions and observations to suggest entry methods preferred by the entrant. Non-limiting examples of a suggestion module may be a system as described in U.S. Pat. No. 7,984,056, issued to Kane; or a system as described in U.S. Patent Publication No.: 2007/0043583, by Davulcu et al.; or a system as described in U.S. Patent Publication No.: 2011/0173095, by Kassaei, which are incorporated for their supporting teachings herein.

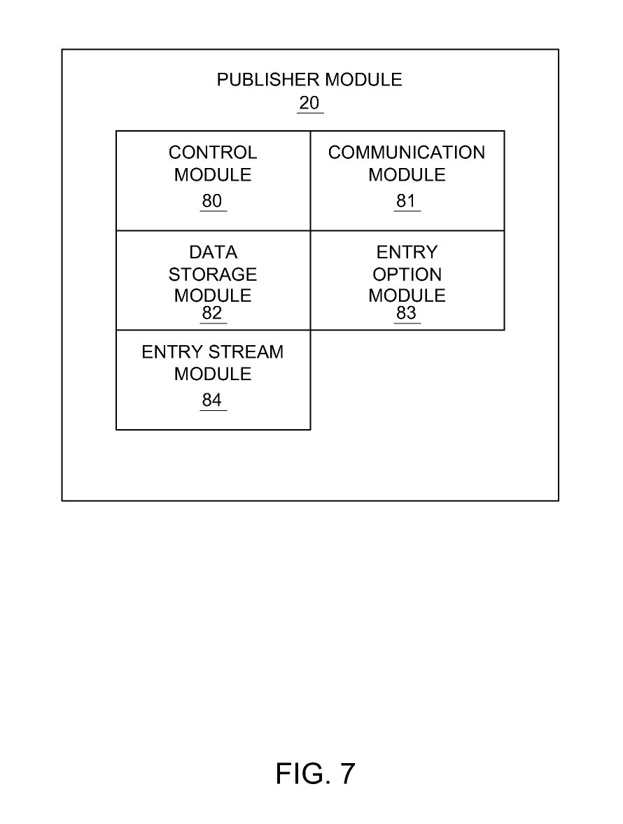

FIG. 7 is a module diagram of a publisher module of a contest management system, according to one embodiment of the invention. There is shown a publisher module 20 including a control module 80, a communication module 81, a data storage module 82, an entry option module 83, and an advertising module 84.

The illustrated publisher module 20 is in communication with a plurality of entrant interface modules 14 of a contest management system over a computerized network. The publisher module 20 publishes a plurality of diverse action requirement sets associated with the contest, each action requirement set associated with a diverse contest sponsor, over a computerized network. The publisher module 20 publishes a live streaming feed of contest entries.

The illustrated publisher module 20 includes a control module 80 provides operational instructions and commands to the modules and components of the publisher module 20. The control module 80 is in communication with the modules and components of the contest management system (and/or other modules described herein) and provides managerial instructions and commands thereto. The source of such instructions/commands may be from one or more other modules described herein and/or through interactions between one or more other modules described herein. The control module 80 sets parameters and settings for each module and component of the publisher module 20.

The illustrated publisher module 20 includes a communication module 81, such as a network card, system bus, or wireless communication module, and communicates with a computerized network. The communication module 81 provides communication capabilities, such as wireless communication, to the modules and components of the publisher module 20 and the components and other modules described herein. The communication module 81 provides communication between a wireless device, such as a mobile phone, and a computerized network and/or to facilitate communication between a mobile device and other modules described herein. The communication module 81 may have a component thereof that is resident on a user's mobile device.

The illustrated publisher module 20 includes a data storage module 82 in communication with the modules and components of the publisher module 20. The data storage module 82 collects and store data for each of the modules of the publisher module 20. The data storage module 82 is in communication with the various modules and components of the system for managing a contest over a computerized network and stores data transferred there through. The data storage module 82 stores data transferred through each of the modules of the publisher module, thereby updating the contest management system and the publisher module with up to date data and real time publisher and user data. The data storage module 82 securely stores user data along with data transferred through the publisher module 20.

The illustrated publisher module 20 is in communication with an entrant interface module of a contest management system over a computerized network. The publisher module 20 includes an entry option module 83 that publishes a plurality of diverse action requirement sets associated with the contest, each action requirement set associated with a diverse contest sponsor, over a computerized network.

The illustrated publisher module 20 includes an entry stream module 84 that is in communication with a contest management module of the contest management system over a computerized network. The entry stream module 84 publishes a live streaming feed of contest entries that may include: descriptive information about entry actions taken by entrants, and a machine executable link to a user interface wherein users may take similar entry actions.

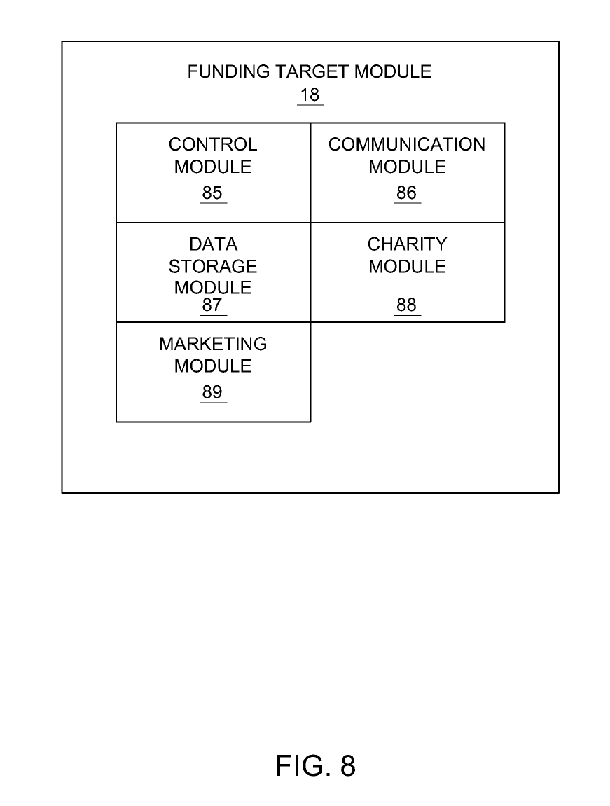

FIG. 8 is a module diagram of a funding target module of a contest management system, according to one embodiment of the invention. There is shown a funding target module 18 including a control module 85, a communication module 86, a data storage module 87, a charity module 88, and a marketing module 89.

The illustrated funding target module 18 is in communication with a contest management module and a plurality of entrant interface modules of a contest management system over a computerized network. The funding target module 18 rewards a charity with a portion of the revenue generated by the contest. The minimum condition set includes a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

The illustrated funding target module 18 includes a control module 85 provides operational instructions and commands to the modules and components of the funding target module 18. The control module 85 is in communication with the modules and components of the contest management system (and/or other modules described herein) and provides managerial instructions and commands thereto. The source of such instructions/commands may be from one or more other modules described herein and/or through interactions between one or more other modules described herein. The control module 85 sets parameters and settings for each module and component of the funding target module 18.

The illustrated funding target module 18 includes a communication module 86, such as a network card, system bus, or wireless communication module, and communicates with a computerized network. The communication module 86 provides communication capabilities, such as wireless communication, to the modules and components of the funding target module 18 and the components and other modules described herein. The communication module 86 provides communication between a wireless device, such as a mobile phone, and a computerized network and/or to facilitate communication between a mobile device and other modules described herein. The communication module 86 may have a component thereof that is resident on a user's mobile device.

The illustrated funding target module 18 includes a data storage module 87 in communication with the modules and components of the funding target module 18. The data storage module 87 collects and store data for each of the modules of the funding target module 18. The data storage module 87 is in communication with the various modules and components of the system for managing a contest over a computerized network and stores data transferred there through. The data storage module 87 stores data transferred through each of the modules of the sponsor module, thereby updating the contest management system and the funding target module with up to date data and real time funding target and user data. The data storage module 87 securely stores user data along with data transferred through the funding target module 18.

The illustrated funding target module 18 includes a charity module 88 in communication with the modules and components of the funding target module 18. The charity module 88 designates a charity or a plurality of charities to reward a portion of the revenue generated by the contest provided by a contest management system over a computerized network. Non-limiting examples of a charity module may be a system as described in U.S. Patent Publication No.: 2012/0317044, by Massarik; or a charity management system as described in U.S. Patent Publication No.: 2010/0017217, by Olliphant, which are incorporated for their supporting teachings herein.

The illustrated funding target module 18 includes an advertising module 89 in communication with the modules and components of the funding target module 18. The advertising module 89 provides advertising to funding targets, publishers, or merchants associated with a contest management system over a computerized network. Non-limiting examples of an advertising module may be an advertising module as described in U.S. Patent Publication No.: 2009/0144159, by Bashyam; or a system as described in U.S. Patent Publication No.: 2009/0307082, by Raghunathan et al., which is incorporated for their supporting teachings herein.

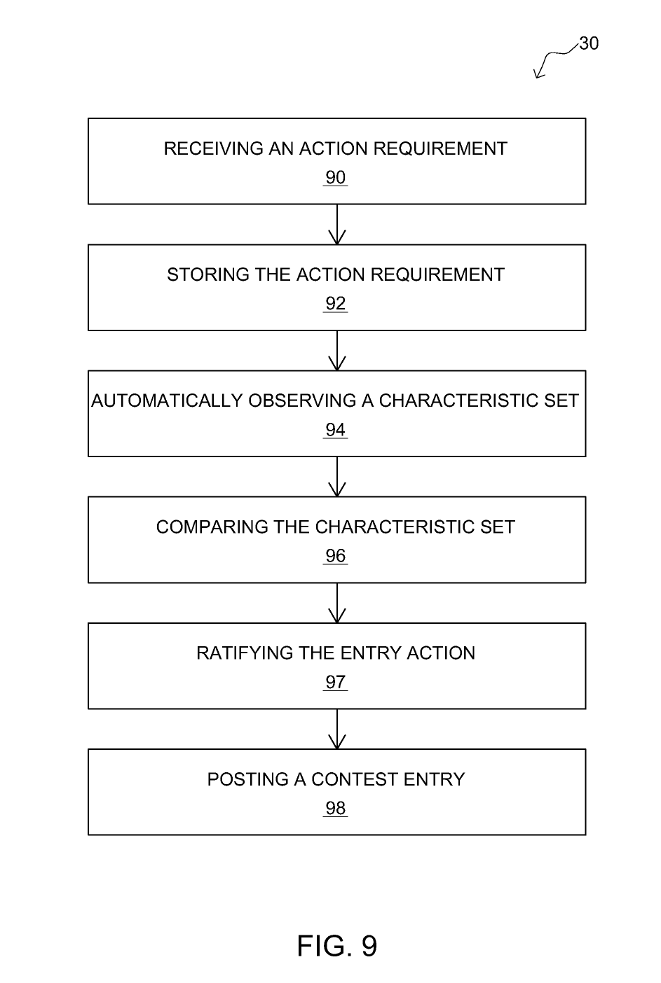

FIG. 9 is a flowchart of a method of managing a contest, according to one embodiment of the invention. There is shown a method of managing a contest using a contest management system over a computerized network. Such a method may be performed by one or more of the modules described herein and may include one or more steps described herein and/or may be performed in one or more of the manners described herein.

According to one embodiment of the invention, there is a method of managing a contest system 30 over a computerized network. The method includes the step of receiving an action requirement set from a contest sponsor, wherein the action requirement set may include a minimum condition set of entry actions for a sponsor to fund a contest entry 90. Receipt may be through a mere data transfer over a predefined protocol, such as wherein the interaction is highly automated and expected to repeat. Receipt may be through a user interface module, such as but not limited to a graphical user interface module, wherein a sponsor determines/selects/configures/programs and/or records one or more minimum condition sets, each set including one or more minimum conditions that may be expressed as one or more logical statements, such as but not limited to IF-THEN, TRUE/FALSE or EQUALS type logical statements. Receipt may be through custom programming of a sponsor module to meet specific needs of a sponsor as to minimum condition sets. Other similar modes of receipt may be includes. The minimum condition set may include a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

The method 30 includes the step of storing the action requirement set in association with a contest in a memory storage device 92, such as but not limited to storing an action requirement set as a record associated with a record regarding the sponsor and the contest to be sponsored. The method 30 includes automatically observing, using a computing device over a computerized network, a characteristic set of an entry action by an entrant 94. Such may occur by providing a user interface module whereby entrants may perform such actions, as in a website and/or mobile application wherein a video may be viewed and through such website the entrants IP addressed may be tied to confirmation from the website, browser, mobile application and/or media file server that the video has indeed played to a sufficient degree to count as a valid entry associated with the entrant identified by IP address and/or other contact information. Such may occur by using webcrawlers, spider, bots and the like to automatically search for, analyze and/or otherwise gather information regarding prospective entry actions. The method 30 includes the step of comparing the characteristic set against the minimum condition set, using a processor 96. The method includes the step of ratifying, automatically, the entry action to a contest management module if the characteristic set satisfies the minimum condition set 97. This may generally be performed by comparing observed/recorded data for matches between entry actions and action requirements to see if the entry actions at least meet the action requirements. It is generally helpful to express and observe entry actions and associated requirements in manners where automated comparison of the same is easy, such as but not limited to an action requirement being that a TRUE “action1” flag be associated with an email address that matches an email address of an entry that is associated with a requested contest entry through an “action1” entry type.

The method of managing a contest system over a computerized network includes the step of automatically issuing a debit instruction to an account of the contest sponsor in association with ratifying the entry action. Such may be accomplished by recording a debit entry into a database including the amount to be debited, the date/time of the entry, an entry identification number unique to the entry so associated, and a ratification number provided by a sponsor module that is associated with ratification of the associated entry. Such debit entries may then be automatically tabulated at a particular time or according to a schedule and then formal financial transactions may be processed between the sponsor and the contest managers according to the aggregate. The method 30 includes the step of posting a contest entry associated with the entrant if the entry action is ratified 98. Such may occur by recording an entry record into a pool/table of entry records and may include one or more of a unique entry number, entry time, entry posting time, entry action performed, funding target associated with the entry, sponsor associated with the entry, entry fee payment validation number, entry fee payment amount, contact information associated with the entrant, a ratification/validation code, and the like and combinations thereof. The method includes the step of rewarding a winning entrant for winning a contest based on a ratified entry action by the winning entrant, wherein the entry action by the winning entrant did not include paying any money. Such may include automatically contacting the entrant to notify them of their award and providing information in regards to how to collect the award. The method includes the step of rewarding a funding target with a predetermined portion of the revenue generated from a contest, including revenue derived from the contest sponsor.

The method of managing a contest system over a computerized network includes the step of automatically incrementing an award associated with the contest in association with automatically debiting an account of the contest sponsor. Such may create a progressive award of fungible assets (money) that is ever increasing as more and more entrants participate and as more and more sponsors pay additional entry fees for the actions that entrants perform. Prizes/awards and/or portions thereof may carry over from one contest to another, similar to how some lotteries are held. The method includes the step of publishing a plurality of diverse action requirement sets associated with the contest, each action requirement set associated with a diverse contest sponsor, over a computerized network. Where such is done, entrants may be able to see how others are gaining additional entries and do the same for themselves, thus allowing entrants brought in through one sponsor to be exposed to other sponsors as well, thereby automatically cross-pollinating the reach of such unrelated sponsors without those sponsors having to coordinate, communicate or even know of the other. The method includes the step of publishing a streaming feed of contest entries including: descriptive information about entry actions taken by entrants, and/or a machine executable link to a user interface wherein users may take similar entry actions. Thereby, on viewing such a feed, entrants and/or viewers may be able to automatically and easily be directed to an appropriate user interface module (generally a website or mobile device application) wherein they may perform entry actions and/or otherwise gain entries into the contest.

According to one embodiment of the invention, there is a method of managing a contest system over a computerized network. The method includes the step of receiving an action requirement set from a contest sponsor, wherein the action requirement set may include a minimum condition set of entry actions for a sponsor to fund a contest entry and the minimum condition set does not include payment of money. The method includes the step of storing the action requirement set in association with a contest in a memory storage device. The method includes the step of automatically observing, using a computing device over a computerized network, a characteristic set of an entry action by an entrant. The method includes the step of comparing the characteristic set against the minimum condition set, using a processor. The method includes the step of ratifying, automatically, the entry action to a contest management module if the characteristic set satisfies the minimum condition set. The method includes the step of automatically issuing a debit instruction to an account of the contest sponsor in association with ratifying the entry action. The method includes the step of posting a contest entry associated with the entrant if the entry action is ratified. The method includes the step of automatically incrementing an award associated with the contest in association with posting the contest entry.

The method of managing a contest system over a computerized network includes the step of rewarding a winning entrant for winning a contest based on a ratified entry action by the winning entrant. The method includes the step of rewarding a funding target with a predetermined portion of the revenue generated from a contest. The method includes the step of publishing either a plurality of diverse action requirement sets associated with the contest, each action requirement set associated with a diverse contest sponsor, over a computerized network or a streaming feed of contest entries including: descriptive information about entry actions taken by entrants, and a machine executable link to a user interface wherein users may take similar entry actions.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although progressive money prizes are discussed in numerous places herein, it is understood that a contest may have one or more prize and/or one or more type/style of prize/contest, including but not limited to those that may be characterized as: sweepstakes, giveaways, instant win, coupons, linked contest series, bonus prizes, skill/achievement based, and the like and combinations thereof.

Additionally, although the figures illustrate specific connections and flows of process, it is understood that the variations of connections and process flows that may be configured to perform the method and/or generate the system described herein are plethoric and that many connections described herein, explicitly and/or inherently, are not illustrated but may be easily illustrated by arrow(s), connecting line(s), and/or adjacentcy.

It is also envisioned that the actions taken by entrants may be varied and plethoric and may be beyond what is necessarily required by a sponsor module for validation, including but not limited to viewing a video, sharing information on a social network, following/liking/etc. a particular target on a social media platform, broadcasting a message (e.g. tweeting), voting in a poll, performing a mobile check-in at a physical location, uploading a file, downloading a file, subscribing to a newsletter/feed/email campaign/etc., taking a survey and the like and combinations thereof. Further, instructions for how to execute a valid contest entry may be unclear, puzzling, indirect, inherent, or otherwise not directly associated with information stored in the sponsor module. Such, especially combined with an entry feed providing clues, may enable further gamification of a contest, wherein entrants must puzzle out the various ways to create valid entries. Such may enhance the viral distribution, interactivity, and fun of such a contest. Published material by the system may be searchable, filterable, sortable and the like by entrants, sponsors, third parties, the public at large, the contest management system itself, funding targets and the like and combinations thereof and one or more such entities may be restricted from one or more aspects of the same by the system.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A method of managing a contest system over a computerized network, comprising the steps of:
a) receiving an action requirement set from a contest sponsor, wherein the action requirement set includes a minimum condition set of entry actions for a sponsor to fund a contest entry;
b) storing the action requirement set in association with a contest in a memory storage device;
c) automatically observing, using a computing device over a computerized network, a characteristic set of an entry action by an entrant;
d) comparing the characteristic set against the minimum condition set, using a processor;
e) ratifying, automatically, the entry action to a contest management module if the characteristic set satisfies the minimum condition set;
f) automatically issuing a debit instruction to an account of the contest sponsor in association with ratifying the entry action; and
g) posting a contest entry associated with the entrant if the entry action is ratified.

2. The method of claim 1, further comprising the step of rewarding a winning entrant for winning a contest based on a ratified entry action by the winning entrant, wherein the entry action by the winning entrant did not include paying any money.

3. The method of claim 1, further comprising the step of rewarding a funding target with a predetermined portion of the revenue generated from a contest, including revenue derived from the contest sponsor.

4. The method of claim 1, further comprising the step of automatically incrementing an award associated with the contest in association with automatically debiting an account of the contest sponsor.

5. The method of claim 1, further comprising the step of publishing a plurality of diverse action requirement sets associated with the contest, each action requirement set associated with a diverse contest sponsor, over a computerized network.

6. The method of claim 1, further comprising the step of publishing a streaming feed of contest entries including: descriptive information about entry actions taken by entrants, and a machine executable link to a user interface wherein users may take similar entry actions.

7. The method of claim 1, wherein the minimum condition set includes a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

8. A method of managing a contest system over a computerized network, comprising the steps of:
a) receiving an action requirement set from a contest sponsor, wherein the action requirement set includes a minimum condition set of entry actions for a sponsor to fund a contest entry and the minimum condition set does not include payment of money;
b) storing the action requirement set in association with a contest in a memory storage device;
c) automatically observing, using a computing device over a computerized network, a characteristic set of an entry action by an entrant;
d) comparing the characteristic set against the minimum condition set, using a processor;
e) ratifying, automatically, the entry action to a contest management module if the characteristic set satisfies the minimum condition set;
f) automatically issuing a debit instruction to an account of the contest sponsor in association with ratifying the entry action;
g) posting a contest entry associated with the entrant if the entry action is ratified; and
h) automatically incrementing an award associated with the contest in association with posting the contest entry.

9. The method of claim 8, further comprising the step of rewarding a winning entrant for winning a contest based on a ratified entry action by the winning entrant

10. The method of claim 9, further comprising the step of rewarding a funding target with a predetermined portion of the revenue generated from a contest.

11. The method of claim 10, further comprising the step of publishing either a plurality of diverse action requirement sets associated with the contest, each action requirement set associated with a diverse contest sponsor, over a computerized network or a streaming feed of contest entries including: descriptive information about entry actions taken by entrants, and a machine executable link to a user interface wherein users may take similar entry actions.

12. The method of claim 11, wherein the minimum condition set includes a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

13. A contest management system for managing a contest over a computerized network, comprising:
a) a contest management module that manages a progressive prize contest over a computerized network and posts a contest entry associated with an entrant if an associated entry action is ratified;
b) an entrant interface module in communication with the contest management module, wherein the entrant interface module provides an interactive user interface to an entrant and automatically observe, using a computing device over a computerized network, a characteristic set of an entry action by an entrant; and
c) a sponsor module in communication with the contest management module and the entrant interface module, wherein the sponsor module:
compares the characteristic set against a stored minimum condition set, using a processor;
ratifies, automatically, the entry action to the contest management module if the characteristic set satisfies the minimum condition set; and
automatically issues a debit instruction to an account of the contest sponsor in association with ratifying the entry action.

14. The system of claim 13, wherein the contest management module, includes:
a) prize module that increments a progressive prize in association with ratified entries;
b) an entry feed generation module in communication with a computerized network, wherein the entry feed generation module publishes a streaming feed of contest entries including: descriptive information about entry actions taken by entrants, and a machine executable link to a user interface wherein users may take similar entry actions;
c) an account management module in communication with the entry feed generation module, wherein the account management module manages an account of an entrant; and
d) a validation module in communication with the account management module, wherein the validation module validates contest entries in association with ratified entry information received from the sponsor module.

15. The system of claim 13, wherein the entrant interface module includes:
a) an account interface module that facilitates user management of an account of an entrant;
b) an interface module in communication with the account module, wherein the interface module provides a graphical user interface for an entrant;
c) an observation module in communication with the account module, wherein the observation module observes entry actions; and
d) a suggestion module in communication with the account interface module and interface module, wherein the suggestion module provides suggestions over the interface module regarding entry methods for entries into a contest over a computerized network.

16. The system of claim 13, wherein the sponsor module, includes:
a) an comparison module that compares the characteristic set against a stored minimum condition set, using a processor, wherein the minimum condition set does not include the entrant paying a fee;
b) a ratification module in communication with the comparison module, wherein the ratification module ratifies, automatically, the entry action to a contest management module if the characteristic set satisfies the minimum condition set; and
c) a debit module in communication with the ratification module, wherein the debit module automatically issues a debit instruction over a computerized network to an account of the contest sponsor in association with ratifying the entry action and issues an associated credit instruction to an account of the contest management module.

17. The system of claim 13, further comprising a publisher module in communication with the entrant interface module, including at least one of:
a) an entry option module that publishes a plurality of diverse action requirement sets associated with the contest, each action requirement set associated with a diverse contest sponsor, over a computerized network; or
b) an entry stream module in communication with the contest management module, wherein the entry stream module publishes a live streaming feed of contest entries including: descriptive information about entry actions taken by entrants, and a machine executable link to a user interface wherein users may take similar entry actions.

18. The system of claim 13, further comprising a funding target module in communication with the contest management module and the entrant interface module, wherein the funding target module rewards a charity with a portion of the revenue generated by the contest.

19. The system of claim 13, wherein the minimum condition set includes a machine observable condition selected from the group of conditions consisting of: accessing a particular media file, sharing information over a computerized social network, broadcasting a message over a computerized network, voting in a poll, completing a survey, uploading a file to a computerized network, downloading a file from a computerized network, and subscribing to a subscription list.

20. The system of claim 17, wherein:
a) the contest management modules includes:
a1) prize module that increments a progressive prize in association with ratified entries;
a2) an entry feed generation module in communication with a computerized network, wherein the entry feed module publishes a streaming feed of contest entries including: descriptive information about entry actions taken by entrants, and a machine executable link to a user interface wherein users may take similar entry actions;
a3) an account management module in communication with the entry feed generation module, wherein the account management module manages an account of an entrant; and
a4) a validation module in communication with the account management module, wherein the validation module validates contest entries in association with ratified entry information received from the sponsor module; and
b) the sponsor module includes:
b1) a comparison module that compares the characteristic set against a stored minimum condition set, using a processor, wherein the minimum condition set does not include the entrant paying a fee;
b2) a ratification module in communication with the comparison module, wherein the ratification module ratifies, automatically, the entry action to a contest management module if the characteristic set satisfies the minimum condition set; and
b3) a debit module in communication with the ratification module, wherein the debit module automatically issues a debit instruction over a computerized network to an account of the contest sponsor in association with ratifying the entry action and issues an associated credit instruction to an account of the contest management module.
